(19) United States
(12) Patent Application Publication
(10) Pub. No.: US 2016/0180359 A1
(43) Pub. Date: Jun. 23, 2016

(54) Using Partial Survey to Reduce Survey Non-Response Rate and Obtain Less Biased Results

(71) Applicant: Yongming Qu, Carmel, IN (US)

(72) Inventor: Yongming Qu, Carmel, IN (US)

(21) Appl. No.: 14/576,339

(22) Filed: Dec. 19, 2014

(51) Int. Cl. G06Q 30/02

(52) U.S. Cl. CPC G06Q 30/0203

(57) ABSTRACT

Internet makes large-sample web surveys easy and inexpensive. However, the survey non-response rate (or missing response) is generally high. It is reasonably expected that the survey non-response rate increases as the number of survey questions increases. We propose a partial survey method, in which only a subset of survey questions are distributed to each tester and different testers may receive different questions. Then, the tester can spend much less time responding a short survey compared to the full survey (which includes all survey questions), and therefore it is less likely for a tester to decline the survey and hence increases survey response rate. A mixed survey, composed of the partial survey and full survey, is as well as an extrapolation estimator were also proposed and studied. Simulation was conducted and showed the partial survey produces less biased estimator for the mean response and regression coefficients than the full survey, but with increased standard error for the estimation. The partial survey provides much less mean squared error for the mean response compared to the full survey.

### TECHNICAL FIELD

This invention relates to a statistical method to reduce survey non-response rate and to obtain better estimates for mean survey response and regression coefficients. It is especially useful for large scale web-based survey.

### BACKGROUND

Internet makes large-sample web surveys easy and inexpensive. However, research showed the response rate was approximately 50% (Archer, 2008). If the non-response or missing response is not random (the probability of non-response depends on unobserved factors) and the non-response rate is high, it could produce biased results. It is reasonable to assume that the non-response rate depends on the number of survey questions. Therefore, a short survey with very few questions is preferred. However, a short survey may not meet the need of collecting the complete information to fully understand the problem of interest.

Let see why the response ignoring the missing values can introduce bias. Let K denote the number of survey questions and Y=(Y₁, Y₂, . . . , Y_{K})′ are the response variables. Let Z be a latent variable that cannot be observed and determines the probability of missing π through a logistic model:

$$log ( \frac{π}{1 - π} ) = a + ( \frac{M}{K} ) bZ$$

Let R be a binary variable denoting whether the survey is missing such that R=1 for Y being missing and R=0 for Y being observed (responded). The mean observed response is E[Y|R=0], while the interested mean response is E[Y]. It is well known that

E[Y]=E[Y|R=1]P(R=1)+E[Y|R=0]P(R=0)

Only when the response Y is independent of the missing indicator R, E[Y]=E[Y|R=0]. Generally, simply ignoring the missing responses will produce biased estimator for the mean response. Although there are some techniques such as inverse weighted estimator to achieve less biased estimator provided that weights are known or can be estimated consistently. However, it is generally a challenge to estimate the weight due to two factors:
The variables that influences the weights and exact functional form are not unknown
The variables that influence the weights may not always be observed

Therefore, reducing the non-response rate is critical to ensure the validity of the survey.

### SUMMARY OF INVENTION

### Technical Problem

The purpose of this invention is to provide a new survey sampling method as well as estimation methods to construct estimates for the mean response and the relationship between survey questions. This method works ideally for web-based survey where thousands or millions of users can be accessed but the survey response rates are generally low.

### Solution to Problem

The principle of this proposed partial survey method is to reduce the number of questions each test has to answer. Then, the time for each tester to complete the survey will be reduced, and the overall survey response rate can be improved. There are a couple of ways to achieve this goal.

The simplest approach is called partial survey with M survey questions [PS(M)], where M is an positive integer less than the total number of survey questions (K). For each tester, M questions are randomly selected from the total set of K survey questions, and are assigned to this tester with certain probability. Then, the survey results are a kind of incomplete data as no tester responds all questions. The mean (for continuous variables) or proportion (for categorical variables), as well as the variance for a question can be estimated by simply using the non-missing response for this question. The variance-covariance between all survey questions can be estimated by variance (for diagonal elements) and pairwise covariance (for off diagonal elements). The regression coefficients can be estimated using the relationship between regression coefficients and the mean and variance-covariance matrix.

A more complex approach is to assign different testers with different numbers of questions (not all testers receive the same number of survey questions) and using extrapolation method to construct the estimators (call this method as partial survey with extrapolation [PSE]). Then, for each group of testers with the same number of questions, the mean and response coefficients (T) can be estimated using the PS(M) method, and the survey non-response rate (p) can be estimated. Then, a series of pair data for the survey non-response rate and the corresponding estimators of interest are available. A regression of T on p can be performed and the extrapolation estimator is the estimated value on the regression curve at p=0.

### Advantageous Effect of Invention

The partial survey methodology as well as the estimation methods are proposed and studied through simulation. The advantage of partial survey method is that it reduces the survey non-response rate and hence produces less biased estimators. Based on the stimulation, PS2 and PSE have the better performance for estimation of mean response in both bias and MSE compared to FS, the traditional full survey method. The PS2 and PSE also have smaller bias for the estimation of the regression coefficients compared to FS. Therefore, the partial survey method is an innovative survey method that can be applied to web-based survey where thousands and millions of testers can be reached.

### BRIEF DESCRIPTION OF DRAWINGS

FIG. 1 describes the steps to conduct Partial Survey of 2 questions (PS2) and obtain the estimation.

FIG. 2 describes the steps to conduct Partial Survey with Extrapolation

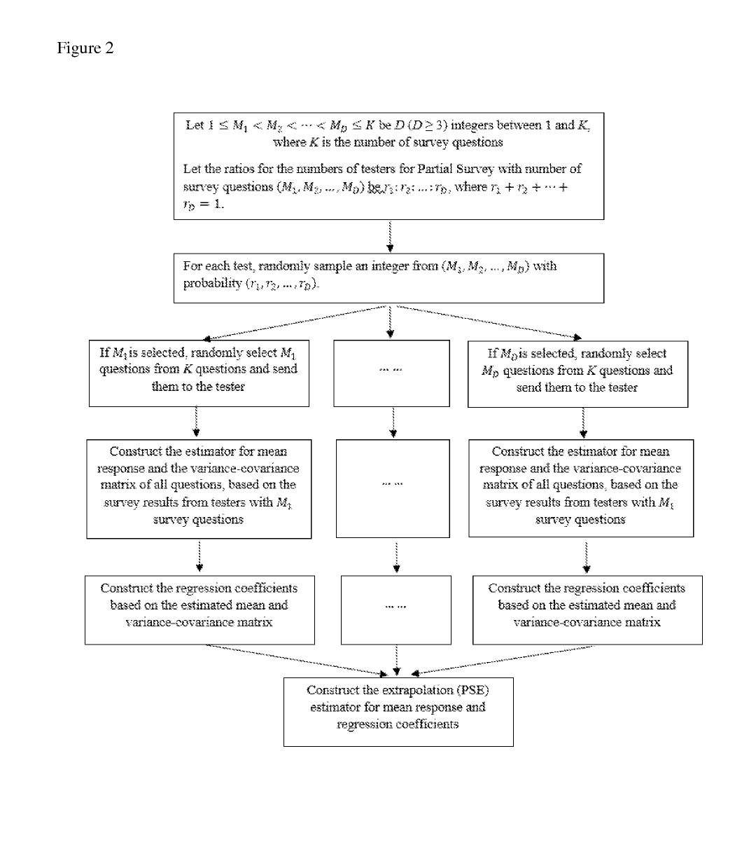

### DETAILED DESCRIPTION OF PREFERRED EMBODIMENTS

### Statistical Methods

Let K denote the number of survey questions. Since internet can essentially reach almost everyone without major cost, the survey sample could be very large. Let N denote the survey sample (which is generally in the magnitude of hundreds of thousands or millions). We call a person who receive the survey as a tester. Instead of sending all survey questions to each tester, only a subset of survey questions are randomly sent to the tester. For example, if there are a total of 20 questions and each tester only receives 2 questions, there are)(₂²⁰=190 possible ways of selecting 2 questions. If a million people are surveyed, approximately each pair of questions can be surveyed from 1000000/190=5263 testers, which is still a very large sample. Let M denote the number of partial survey question and we call the survey method as Partial Survey with M questions (PSM).

Here are what to be considered for selecting M:
The purpose of the survey. If the purpose of the survey is only for the mean response, then M=1 can meet the need. We use “mean response” as a general term for the parameter of first moment. For a continuous variable, it is the mean value; for categorical variable, it is the proportions. If the purpose of the survey is for the mean response and the linear regression between survey questions, M=2 is the minimal.
The targeted survey sample. The smaller the survey sample, the less likelihood a small M can achieve the necessary number of survey responders for each question.

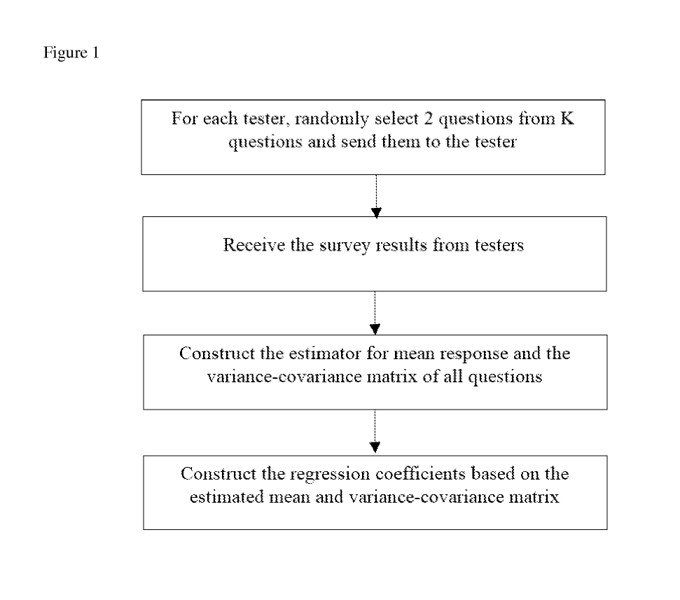

The steps are PSM method can be outline as follows (see FIG. 1):
1. For each variable, the mean can be estimated just based on the non-missing response, denoted by \hat{μ}_{y}.
2. The pairwise covariance can be constructed for each pair only using the subsamples that are surveyed for this pair of questions. Let □ denote the variance-covariance matrix of the response variable Y. The variance-covariance matrix can be estimated by pairwise covariance of non-missing values for each pair, say, \hat{Σ}. For each pair of questions, the probability of one tester receiving the pair is

$$\frac{( \begin{matrix}K - 2 \\ M - 2\end{matrix} )}{( \begin{matrix}K \\ M\end{matrix} )} ,$$

where

$$( \begin{matrix}K \\ M\end{matrix} )$$

is the number of possible ways of selecting M questions from K questions. Assume the non-response rate pₘ is the same for all testers, regardless of the questions they received and it can be estimated by the proportion of non-responders. Then, the expected number of responders for each pair is

$${N}_{e} = N \frac{( \begin{matrix}K - 2 \\ M - 2\end{matrix} )}{( \begin{matrix}K \\ M\end{matrix} )} {p}_{m} \qquad ( 1 )$$

3. Let say one intends to regress Yₖ on Y_{A}, where Y_{A} is a subset of questions not including Yₖ. Let Σ_{A} denote the variance-covariance matrix for variables Y_{A} and \hat{Σ}_{A} is the estimator for Σ_{A}. Since the estimated variance-covariance matrix \hat{Σ}_{A} may not be positive definite, a small sample modification can be applied to ensure the coefficients can be estimated without modifying the large sample proprieties. Let λₘᵢₙ be the minimum eigenvalue of \hat{Σ}_{A}. A modified estimator for \hat{Σ}_{A} is

$${\tilde{Σ}}_{A} = \{ \begin{matrix}{\hat{Σ}}_{A} & if {λ}_{min} \geq {N}_{e}^{- 1} \\ {\hat{Σ}}_{A} + ( {N}_{e}^{- 1} - {λ}_{min} ) {I}_{K} & if {λ}_{min} < {N}_{e}^{- 1}\end{matrix} \qquad ( 2 )$$

where I_{K} is the identify matrix with K dimension. Note the choice of small sample modification factor (Nₑ⁻¹−λₘᵢₙ) can be changed to balance the bias and variance of the estimation for β_{A}. The smaller the modification factor, the less bias for the estimator but larger variance.
4. The regression coefficient β_{A} can be constructed as

\hat{β}_{A}=\hat{Σ}_{A}⁻¹\hat{Σ}_{Ak} (3)
where \hat{Σ}_{Ak} is the estimated covariance between Yₖ and Y_{A}. The intercept is estimated as

\hat{β}₀=\hat{μ}ₖ−Y′_{A}\hat{β}_{A} (4)

Generally, the mean response and the relationship between these survey questions through second moments of statistics are sufficient to meet the objectives of the survey. Therefore, we will focus on the method of partial survey with 2 questions (PS2) in the simulation.

Surveys with M≧2 questions allow estimation of higher order of moments, which for example, can be used to estimate the coefficients for polynomial regressions. A drawback for PS with M>2 questions is that (1) the possible combination of M variables is

$$( \begin{matrix}K \\ M\end{matrix} ) ,$$

which is large when M is large, and (2) the proportion of non-response rate increases. If one is especially interested in the relationship among a few key questions, one possible way to do a partial survey where testers may receive survey questions with different number of questions, and the probabilities to distribute various combinations of questions may be different, depending on the importance of variables. When the probabilities of each possible combination of M questions to be surveyed are not equal, the Nₑ for each pair can be calculated by the number of responders for the pair that are used to estimate Σ_{A}, and the small modification factor in Equation (2) can be adapted using the minimum of the Nₑ's or the average of the Nₑ's.

The above estimators for mean response and regression coefficients should perform excellent when the non-response rate is low for partial survey. However, it is possible that even with the fewest number of questions (e.g., PS2), the non-response rate is still high. In this case, we propose a new estimation method called partial survey extrapolation (PSE) estimation to reduce the bias in the estimation for mean response and coefficients.

Let 1≦M₁<M₂< . . . <M_{D}≦K be D≧3 integers between 1 and K. The targeted testers can be divided into D groups randomly with each group receiving partial survey with M_{d} questions [PS(M_{d})]. Then, the mean response can be estimated for each group of testers. Let \hat{μ}_{d} denote the estimator for group d, and R̅_{d} be the proportion of missing survey responses for group d, d=1, 2, . . . , D. The mean response estimator be can constructed by extrapolating then \hat{μ}_{d} to the ideal case of no missing survey response. The extrapolation idea, combined with simulation, is called simulation extrapolation, has been used for estimation of parameters in measurement error models simulation extrapolation (Cook and Stefanski, 1994) and in data with missing observations (Hsu, 2013). Here, we only need extrapolation without simulation. Typically, a quadratic extrapolation function can be used to achieve good results. For example, if using a quadratic extrapolation function ƒ(t)=α₀+α₁t+α₂t², the parameters (α₀, α₁, α₂) can be estimated through a linear regression of \hat{μ}_{d} on (1, R̅_{d}, R̅_{d}²). The extrapolation estimator \hat{μ}* is the estimator for ƒ(t) when t=0 (i.e., when the proportion of missing is equal of 0):

\hat{μ}*=\hat{α}₀

The PSE estimator for the coefficients can be constructed similarly.

### Simulation

In this section, we conduct Monte Carlo simulations to compare the performance of 4 survey methods: full survey with no missing response (FSNM), full survey (FS), PS2 and PSE. FSNM is an ideal but unrealistic case which is used to benchmark the performance of other methods. For FS and PS2, the probability of non-response depends on an unobserved latent variable modelled as

$$log ( \frac{π}{1 - π} ) = a + ( \frac{M}{K} ) bZ \qquad ( 5 )$$

where a and b are constants to control the rate of missing survey responses. The larger the number of survey questions (M) is, the higher probability of non-response. Therefore, the number of missing responses for PS2 is much compared to FS. This makes sense as the non-response rate increases as the survey becomes lengthier.

The response variables Y and the latent variable Z are generated as the following:
1. Generate K+1 variables from multivariate normal distribution with correlation r=0.5
2. Transform the data by the CDF of standard normal distribution to uniform distribution
3. Categorize each variable into a ordinal variable of 5 scales (1 to 5) with equal probability to simulate the case that the survey questions are often ordinal variables
4. The first K ordinal variables are YK and the (K+1)th variable is Z

We study 4 scenarios with various a, b, K and N (Table 0). For each scenario, 10,000 simulations are performed. We only present the simulation results for the mean response for Y₁, Y₂ and Y₃, and the regression coefficients of Y₃ on Y₁ and Y₂ (say β₀, β₁ and β₂) as results for other mean responses or regression coefficients should be similar.

TABLE 0
Scenarios for simulation studies

| Scenario | a | b | K | N | ρₘ for FS | ρₘ for PS2 |
|---|---|---|---|---|---|---|
| 1 | −3.0 | 1.0 | 10 | 2,000 | ~50% | ~92% |
| 2 | −3.0 | 1.0 | 20 | 10,000 | ~50% | ~94% |
| 3 | −2.5 | 2.0 | 10 | 10,000 | ~83% | ~23% |
| 4 | −2.0 | 2.5 | 10 | 10,000 | ~91% | ~39% |

Notation: a and b are used to control the survey nonresponse rate in Equation (5), K is the number of full survey questions, N is the number of testers are surveyed, and ρₘ, is the survey

In the first two scenarios, we assume a=−3, b=1. The non-response rate is approximately 50% for FS, and 92% (K=10) to 94% (K=20) for PS2. Although one could argue the response rate for PS2 should not depend on K, this difference in the response rate between K=10 and K=20 is small and this should not impact the validity of the simulation results. For the first 2 scenarios, the non-response rate is low for PS2, so no PSE estimator is constructed. In Scenario 1, we choose K=10 and N=2,000; and in Scenario 2, we choose K=20 and N=10,000. The results for estimation of the mean response (μ₁, μ₂, μ₃) are presented in Table 1 and the results for the estimation of regression coefficients (β₁, β₂, β₃) are presented in Table 2.

TABLE 1
The bias, standard deviation and mean squared errors for the
mean response for various survey methods based on 10,000 simulations

| | | Scenario 1: K = 10; N = 2,000 | | | Scenario 2: K = 20; N = 10,000 | | |
|---|---|---|---|---|---|---|---|
| Parameter | Method | Bias | SD | MSE | Bias | SD | MSE |
| μ₁ | FSNM | 0.00016 | 0.01401 | 0.00020 | −0.00014 | 0.03169 | 0.00100 |
| | FS | −0.35698 | 0.01932 | 0.12781 | −0.35756 | 0.04323 | 0.12972 |
| | PS2 | −0.00589 | 0.04583 | 0.00213 | −0.01541 | 0.07432 | 0.00576 |
| μ₂ | FSNM | −0.00003 | 0.01408 | 0.00020 | −0.00037 | 0.03181 | 0.00101 |
| | FS | −0.35720 | 0.01941 | 0.12797 | −0.35722 | 0.04292 | 0.12945 |
| | PS2 | −0.00565 | 0.04629 | 0.00217 | −0.01634 | 0.07410 | 0.00576 |
| μ₃ | FSNM | −0.00006 | 0.01410 | 0.00020 | −0.00007 | 0.03186 | 0.00102 |
| | FS | −0.35714 | 0.01932 | 0.12792 | −0.35742 | 0.04362 | 0.12965 |
| | PS2 | −0.00606 | 0.04634 | 0.00218 | −0.01651 | 0.07308 | 0.00561 |

FSNM, full survey with no missing response;
FS, full survey;
PS2, partial survey with 2 questions;
SD, standard deviation;
MSE, mean squared errors.

Table 1 summarizes the simulation results for the estimation of the mean response for Y₁, Y₂ and Y₃ based on 10,000 simulations. FSNM, as an ideal but unrealistic case, unsurprisingly performs best with essentially no bias and minimum standard deviations. FS is seriously biased, as expected. PS2 shows little bias but had the larger standard deviation than FSNM and FS. PS2 also has much smaller mean squared errors (MSE) than the FS method.

TABLE 2
The bias, standard deviation and mean squared errors for the regression coefficients for
various survey methods based on 10,000 simulations

| | | Scenario 1: K = 10; N = 2,000 | | | Scenario2: K = 20; N = 10,000 | | |
|---|---|---|---|---|---|---|---|
| Parameter | Method | Bias | SD | MSE | Bias | SD | MSE |
| β₀ | FS | −0.03868 | 0.03830 | 0.00296 | −0.03860 | 0.08618 | 0.00892 |
| | PS2 | −0.01039 | 0.44969 | 0.20233 | −0.02287 | 0.50359 | 0.25413 |
| β₁ | FS | −0.01813 | 0.01357 | 0.00051 | −0.01861 | 0.03117 | 0.00132 |
| | PS2 | 0.00129 | 0.23713 | 0.05623 | 0.00070 | 0.24604 | 0.06053 |
| β₂ | FS | −0.01816 | 0.01373 | 0.00052 | −0.01781 | 0.03086 | 0.00127 |
| | PS2 | 0.00149 | 0.23725 | 0.05629 | 0.00479 | 0.24535 | 0.06022 |

FS, full survey;
PS2, partial survey with 2 questions;
SD, standard deviation;
MSE, mean squared errors.

Table 2 summarizes the simulation results for the estimation of the regression coefficients based on 10,000 simulations. Since the true regression coefficients are difficult to calculate analytically, we use the mean of the 10,000 simulations based on FSNM method to estimate the true mean. The estimated true coefficients are
β₀=1.13027, β₁=0.31185, β₂=0.31143 for K=10
β₀=1.13115, β₁=0.31150, β₂=0.31141 for K=20

PS estimator has smaller bias, but larger standard deviation and MSE than the FS method.

In order to understand the performance of PS2 and PSEE when the non-response rate is high, we simulate 2 additional scenarios. In both scenarios, we choose K=10 and N=10,000. In Scenario 3, a=−2.5, b=2, which gives non-response rate of 83% for FS and 23% for PS2. In Scenario 4, a=−2, b=2.5, which gives non-response rate of 91% for FS and 39% for PS2. For PSE method, 30% testers were distributed PS2, 35% testers were distributed the partial survey with 3 questions (PS3) and 35% testers were distributed the partial survey with 5 questions (PS5).

Table 3 provides the simulation results for estimation of mean response for Scenarios 3 and 4. The FS method has the largest bias and smallest standard deviation, and PSE method has the smallest bias but largest standard deviation. The bias based on PS2 method is slightly larger than PSE but is much smaller than FS, and the standard deviation from PS2 method is slightly larger than FS, but much smaller than PSE. As a result, PS2 method has the smallest MSE while FS method has the largest MSE.

TABLE 3
The bias, standard deviation and mean squared errors for the mean response for various
survey methods based on 10,000 simulations (K = 10, N = 10,000)

| | | Scenario 3: a = −2.5, b = 2 | | | Scenario 4: a = −2, b = 2.5 | | |
|---|---|---|---|---|---|---|---|
| Parameter | Method | Bias | SD | MSE | Bias | SD | MSE |
| μ₁ | FSNM | 0.00019 | 0.01399 | 0.00020 | −0.00011 | 0.01420 | 0.00020 |
| | FS | −0.77789 | 0.03018 | 0.60602 | −0.86807 | 0.04134 | 0.75526 |
| | PS2 | −0.07872 | 0.03584 | 0.00748 | −0.16475 | 0.04032 | 0.02877 |
| | PSE | 0.02285 | 0.21604 | 0.04719 | 0.05000 | 0.74585 | 0.55879 |
| μ₂ | FSNM | 0.00012 | 0.01402 | 0.00020 | −0.00026 | 0.01420 | 0.00020 |
| | FS | −0.77770 | 0.03081 | 0.60576 | −0.86758 | 0.04133 | 0.75440 |
| | PS2 | −0.07884 | 0.03557 | 0.00748 | −0.16390 | 0.03999 | 0.02846 |
| | PSE | 0.02378 | 0.21719 | 0.04774 | 0.05515 | 0.75963 | 0.58008 |
| μ₃ | FSNM | 0.00007 | 0.01409 | 0.00020 | −0.00010 | 0.01409 | 0.00020 |
| | FS | −0.77786 | 0.03065 | 0.60601 | −0.86813 | 0.04111 | 0.75533 |
| | PS2 | −0.07865 | 0.03579 | 0.00747 | −0.16477 | 0.04000 | 0.02875 |
| | PSE | 0.02104 | 0.21569 | 0.04696 | 0.04465 | 0.75817 | 0.57682 |

FSNM, full survey with no missing response;
FS, full survey;
PS2, partial survey with 2 questions;
SD, standard deviation;
MSE, mean squared errors.

TABLE 4
The bias, standard deviation and mean squared errors for the regression coefficients for
various survey methods based on 10,000 simulations (K = 10, N = 10,000)

| | | Scenario 3: a = −2.5, b = 2 | | | Scenario 4: a = −2, b = 2.5 | | |
|---|---|---|---|---|---|---|---|
| Parameter | Method | Bias | SD | MSE | Bias | SD | MSE |
| β₀ | FS | −0.06432 | 0.06162 | 0.00793 | −0.06837 | 0.08437 | 0.01179 |
| | PS2 | −0.02495 | 0.23272 | 0.05478 | −0.04045 | 0.25160 | 0.06494 |
| | PSE | 0.00235 | 0.81492 | 0.66411 | −0.01120 | 2.27092 | 5.15719 |
| β₁ | FS | −0.05139 | 0.02477 | 0.00325 | −0.06028 | 0.03516 | 0.00487 |
| | PS2 | −0.00019 | 0.10417 | 0.01085 | −0.00592 | 0.11631 | 0.01356 |
| | PSE | −0.00494 | 0.35821 | 0.12834 | −0.01678 | 1.02421 | 1.04928 |
| β₂ | FS | −0.05158 | 0.02499 | 0.00329 | −0.06122 | 0.03502 | 0.00497 |
| | PS2 | −0.00135 | 0.10264 | 0.01054 | −0.00184 | 0.11541 | 0.01332 |
| | PSE | −0.00593 | 0.35909 | 0.12898 | −0.01628 | 1.01856 | 1.03773 |

FS, full survey;
PS2, partial survey with 2 questions;
SD, standard deviation;
MSE, mean squared errors.

Table 4 provides the simulation results for estimation of regression coefficients for Scenarios 3 and 4. FS method has the largest bias in both scenarios for all coefficients. The biases for PS2 and PSEE methods are similar and smaller than FS. However, FS method has the smallest standard deviation and MSE. The standard deviation for PSE is much larger than PS2. Since the bias does not change, but the standard deviation decreases when the total of number testers (N) increase. We expect the MSE of PS2 will be smaller than FS when N is large enough. For example, the standard deviation for N=1,000,000 would be 100^{-1/2}=10⁻¹ of the standard deviation for N=10,000. The MSE for PS2 estimator of □₁ would be approximately 0.00104, which would be smaller than 0.00274, the MSE of FS estimator.

In summary, based on the simulation results from Tables 1-4, it is clear that for mean response and coefficient estimation, PS2 and PSE have the smaller bias and larger standard deviation than FS. The MSE for the mean response estimation based on PS2 and PSE methods is much smaller than FS. For regression coefficients, the MSE based on PS2 and PSE was larger than FS, based on the simulations. However, we expect the MSE for PS2 would be smaller than FS when the survey sample is large enough.

### CITATION LIST

### Non Patent Literature

Archer, T. M. (2008). Response rates to expect from Web-based surveys and what to do about it. Journal of Extension [Online], 46(3) Article 3RIB3. Available at: http://www.joe.org/joe/2008june/rb3.php
Cook J. R. and Stefanski L. A. (1994). Simulation-Extrapolation Estimation in Parametric Measurement Error Models. Journal of the American Statistical Association 89:1314-1328.
Monroe, M. C. and Adams, D. C. (2012). Increasing Response Rates to Web-Based Surveys. Journal of Extension [Online], 46(3) Article 6TOT7. Available at http://www.joe.org/joe/2012december/tt7.php
Yu-Yi Hsu (2013). Reducing parameter estimation bias for data with missing values using simulation extrapolation. PhD dissertation. http://lib.dr.iastate.edu/cgi/viewcontent.cgi?article=4448&context=etd

1. A subset of survey questions were selected and sent to different testers in a survey, which includes but not limited to paper survey, telephone survey, and internet or web-based survey.

2. The method for the estimation of regression coefficients with responses only for a subset of survey questions from each subject, including application of the extrapolation method.
